(19) United States
(12) Patent Application Publication
(10) Pub. No.: US 2025/0266596 A1
(43) Pub. Date: Aug. 21, 2025

(54) POLARIZER

(71) Applicant: Optim Microwave Inc., Camarillo, CA (US)

(72) Inventor: John Mahon, Westlake Village, CA (US)

(21) Appl. No.: 19/053,153

(22) Filed: Feb. 13, 2025

Related U.S. Application Data
(60) Provisional application No. 63/554,727, filed on Feb. 16, 2024.

(51) Int. Cl. H01P 1/17; H01P 3/10; H01P 3/20

(52) U.S. Cl. CPC H01P 1/173; H01P 3/10; H01P 3/20

(57) ABSTRACT

An antenna feed network includes an asymmetric annular waveguide coupled between first and second cylindrical waveguides. The asymmetric annular waveguide is configured to transform a linearly polarized signal propagating in the first cylindrical waveguide into a circularly polarized signal propagating in the second cylindrical waveguide.

### RELATED APPLICATION INFORMATION

This patent claims priority from provisional patent application 63/554,727, entitled POLARIZER, filed Feb. 16, 2024.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Field

This disclosure relates to linear polarization to circular polarization converters for use in antenna feed structures. In particular, this disclosure relates to linear polarization to circular polarization converters for use in cylindrical waveguides.

### Description of the Related Art

Satellite broadcasting and communications systems commonly use separate frequency bands for the uplink to and downlink from satellites. Additionally, one or both of the uplink and downlink may transmit orthogonal right-hand and left-hand circularly polarized signals within the respective frequency band.

Typical antennas for transmitting and receiving signals from satellites may consist of a parabolic dish reflector and a feed network where the uplink and downlink signals travel through a central cylindrical waveguide. A cylindrical waveguide, also commonly called a “circular waveguide”, is a hollow conductive tube with a right circular cross-section. The term “cylindrical waveguide” will be used herein to avoid confusion between the waveguide shape and the circular polarized signals traveling within the waveguide.

An ortho-mode transducer (OMT) may be used to launch or extract orthogonal TE₁₁ linear polarized modes into the cylindrical waveguide of the antenna feed network. TE (transverse electric) modes have an electric field orthogonal to the longitudinal axis of the waveguide. Two orthogonal TE₁₁ modes do not interact or cross-couple, and can therefore be used to communicate different information. A linear polarization to circular polarization converter is required to convert the orthogonal TE₁₁ modes into left-hand and right-hand circular polarized modes for communication with the satellite.

Converting linearly polarized TE₁₁ modes into circularly polarized modes requires splitting each TE₁₁ mode into two orthogonally polarized portions and then shifting the phase of one portion by 90 degrees with respect to the other portion. This may conventionally be done by inserting two or more dielectric, metal, or metal/dielectric vanes, oriented at 45 degrees to the polarization planes of the TE₁₁ modes, into the waveguide. However, assembling the dielectric vanes at the precise angle within the waveguide can be problematic. Errors in assembling the vanes can result in excess return losses and imperfect polarization conversion resulting in cross-talk between the two orthogonally polarized TE₁₁ modes.

### BRIEF DESCRIPTION OF THE DRAWINGS

FIG. 1 is a simplified cross-sectional schematic diagram of an antenna.

FIG. 2 is a longitudinal cross-sectional schematic view of a feed network including a linear polarization to circular polarization converter.

FIG. 3 is a cross-sectional schematic view of a linear polarization to circular polarization converter in a cylindrical waveguide.

FIG. 4 is a perspective view of an embodiment of a linear polarization to circular polarization converter for use in a cylindrical waveguide.

### DETAILED DESCRIPTION

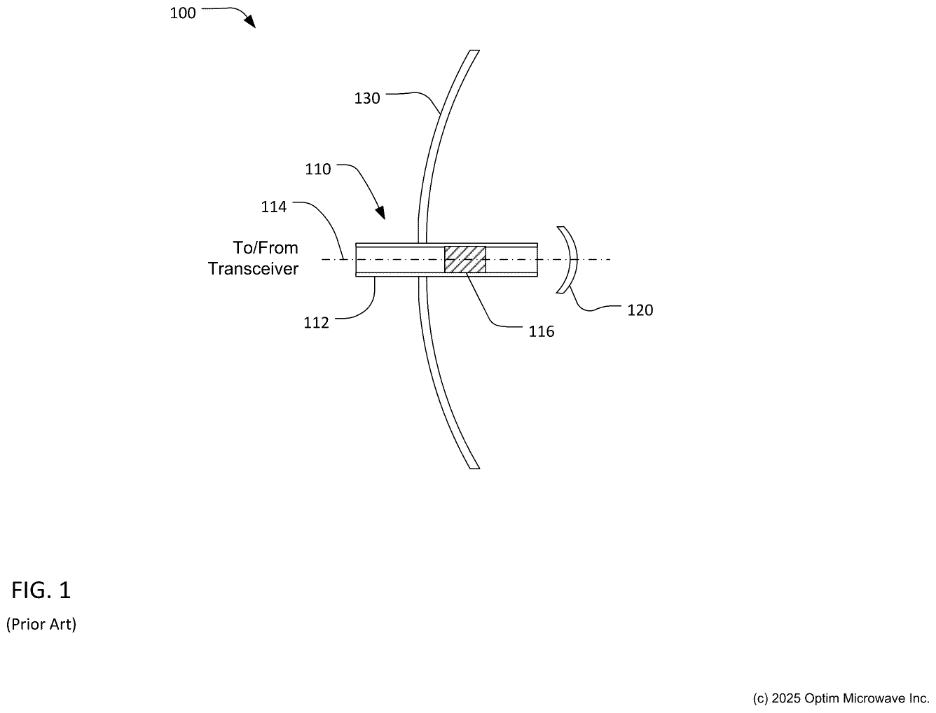

FIG. 1 is a schematic cross-sectional diagram of an antenna 100, which includes a feed network 110, a secondary reflector 120, and a primary reflector 130. The feed network 110 includes a cylindrical waveguide 112 having an axis 114 and a linear polarization to circular polarization converter 116. Radio frequency signals to be transmitted are introduced into the left side of the feed network. Throughout this patent, directional terms (up, down, left, right, etc.) in the discussion of the figures refer to the figure being discussed and do not imply any absolute orientation of the elements being described. In this example, the radio frequency signals may be one or two linearly-polarized signals that propagate in the cylindrical waveguide 110 as orthogonal TE₁₁ modes. The linear polarization to circular polarization converter 116 within the cylindrical waveguide 112 transforms the linearly-polarized signals into circularly-polarized signals the exit the right side of the feed network 110. The circularly-polarized signals are formed into a narrow beam after reflecting from the secondary reflector 120 and the primary reflector 130.

Received radio signals arrive at the primary reflector 130 with circular polarization and are directed into the right side of the feed network 110 by the primary and secondary reflectors 130, 120. The linear polarization to circular polarization converter 116 within the cylindrical waveguide 112 transforms the circularly-polarized signals into linearly-polarized signals that exit the left end of the feed network 110.

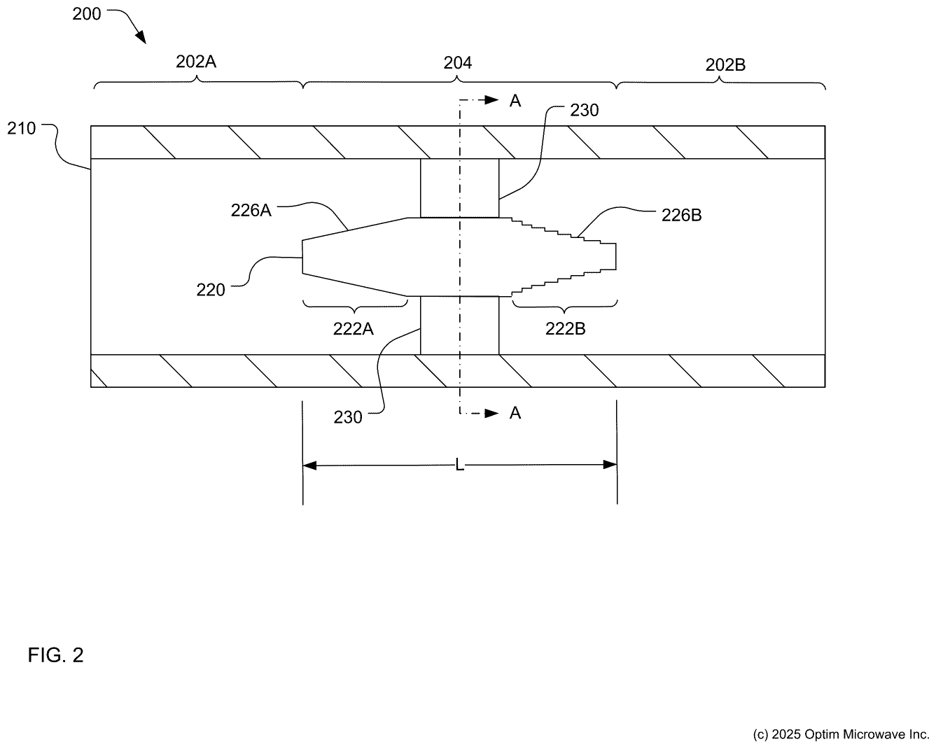

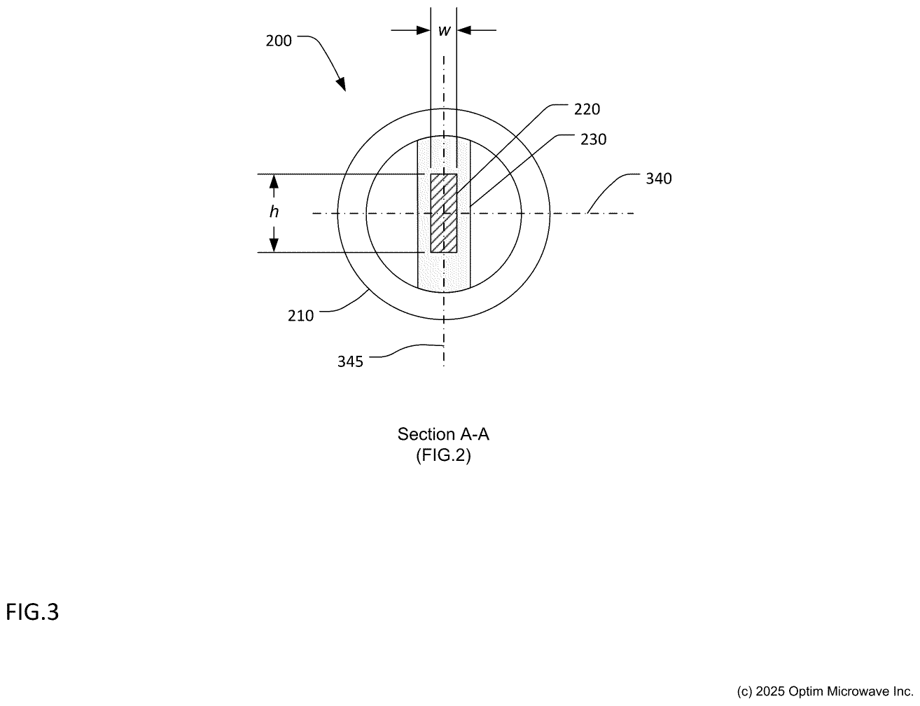

FIG. 2 is a schematic cross-sectional view of a portion of a feed network 200 which may be the feed network 110 of FIG. 1. FIG. 3 is a schematic cross-sectional view of the feed network 200 at section plane A-A. The feed network 200 includes a cylindrical conductive tube 210 and a center conductor 220 which is positioned within the tube 210 by a dielectric support 230. The center conductor 220 and the surrounding portion of the conductive tube 210 form an asymmetric annular waveguide 204. The term “annular waveguide” typically refers to a waveguide formed by the annular space between circular inner and outer conductors. The term “asymmetric annular waveguide” is defined herein as a waveguide formed by the space between an circular outer conductor and an non-circular inner conductor. Portions of the conductive tube not containing the center conductor 220 form cylindrical wave guides 202a, 202b to the left and right of the asymmetric annular waveguide 204.

The conductive tube 210 and the center conductor 220 may typically be made of aluminum but may be some other conductive metal. The dielectric support 230 may be a loss-loss plastic material such as cross-linked polystyrene.

The center conductor 220 and the dielectric support 230 collectively form a polarization converter to convert between linearly-polarized and circularly-polarized signals. To this end, the cross-section shape of the center conductor 220 and/or the dielectric support 230 are not rotationally symmetric. To the contrary, the center conductor 220 is symmetric about a first plane 340 and a second plane 345. The first and second planes 340, 345 are orthogonal and both pass through the axis of the conductive tube. The height h and width w of the center conductor are not equal.

The center conductor 220 may have a rectangular cross-sectional shape as shown in FIG. 3. The center conductor 220 may have a generally rectangular cross-sectional shape, where “generally rectangular” includes rectangular with chamfered, rounded, or notched corners and rectangular with rounded ends. The center conductor 220 may have another cross-sectional shape such as elliptical or other non-circular shape. The cross-sectional shape of the center conductor 220 may vary along the length of the center conductor.

The rotationally asymmetric cross-section of the center conductor 220 and the dielectric support 230 cause a difference in propagation velocity for orthogonal linear-polarized signals propagating through the asymmetric annular waveguide portion 204 of the feed network 200. Specifically signals polarized parallel to the first plane 340 will have a different propagation velocity than signals polarized parallel to the second plane 345. The difference in propagation velocities results in a phase shift between the orthogonal linear-polarized signals after propagation through the asymmetric annular waveguide portion 204 of the feed network 200. To convert between linearly-polarized and perfectly circularly-polarized signals requires a phase shift of 90 degrees. Both the center conductor 220 and the dielectric support 230 contribute to the phase shift. The relative contribution of the center conductor 220 and the dielectric support 230 can be optimized to increase the frequency bandwidth over which the polarization converter provides the desired phase shift. The center conductor 220 and the dielectric support 230 may be configured to provide a phase shift of 90 degrees within a small tolerance (for example, ±3 degrees) over a specified operating frequency band. The specified operating frequency band may be an uplink band, a downlink band, or both uplink and downlink bands. The specified frequency bands will typically be frequency bands reserved for communications between satellites and earth stations.

In addition to providing the desired phase shift, the center conductor 220 and dielectric support 230 must be configured to minimize the insertion loss of the feed network 200. To this end, marginal portions 222A and 222B of the center conductor 220 may be tapered from a smaller cross-sectional area to a larger cross-sectional area to provide impedance matching between the cylindrical waveguide portions 202A and 202B and the center portion of the asymmetric annular waveguide 204. For example, the center conductor may taper linearly (as shown at 226A) or in a series of steps (as shown at 226B), or in some other manner.

The asymmetric annular waveguide 204 may form a resonant cavity for specific frequencies of unwanted modes. Thus, the center conductor 220 and dielectric support 230 must be configured to ensure these resonance frequencies are outside of the specified operating frequency bands of the feed network. The spacing between the resonance frequencies is highly dependent on the length L of the asymmetric annular waveguide. The length L of the center conductor 220 is defined parallel to the axis of the cylindrical tube 210. Resonances occur at signal frequencies where the length L is approximately an integer multiple of one-half the wavelength (in the asymmetric annular waveguide 204) of the signal.

The spacing (i.e., frequency difference) between adjacent resonance frequencies is inversely dependent on the length L such that increasing L reduces the spacing. At some length Lmax, the spacing between adjacent resonance frequencies will be equal to the bandwidth of the specified operating frequency band. L must be less than Lmax to allow adjacent resonance to straddle the specified operating frequency band. Decreasing L increases the spacing between adjacent resonance frequencies and eases the problem of keeping resonances outside of the specified operating frequency band. However, at some point, L may be too small to provide the required impedance matching and phase shift. Since both the frequencies and spacing of the resonances depend on L, only discrete values or narrow ranges of L will satisfy the requirement that all resonances are outside of the specified operating frequency band.

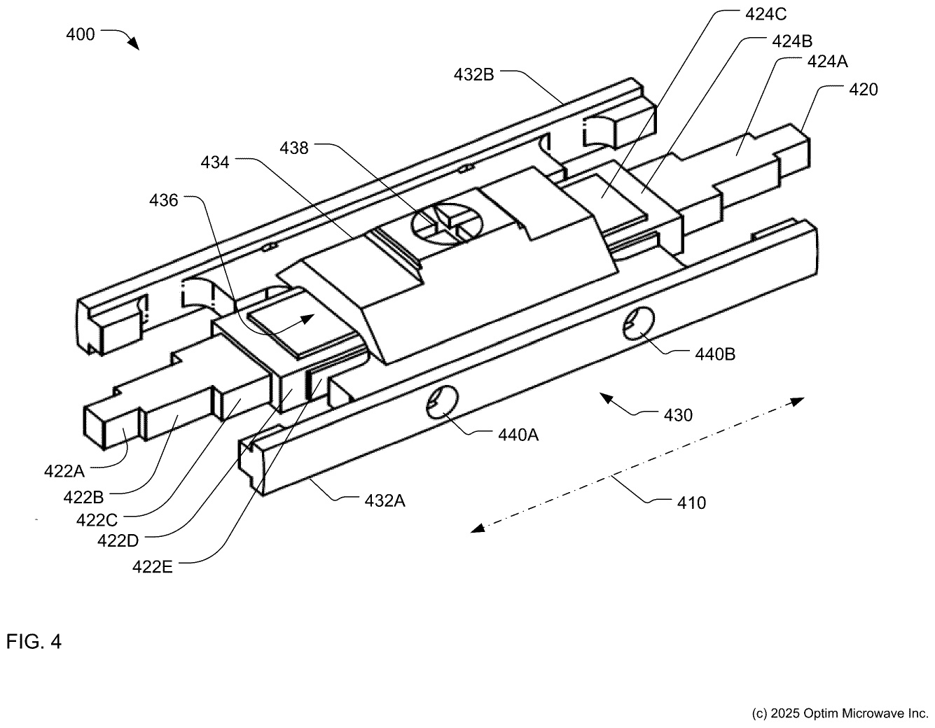

FIG. 4 is a perspective view of a specific embodiment of a linear polarization to circular polarization converter 400 for use in a circular waveguide (not shown). The polarization converter 400 includes a center conductor 420 and a dielectric support 430. The center conductor 420 has a generally rectangular cross-section. Marginal portions of the center conductor 420 are tapered in steps (e.g. steps 422A, 422B, 422C, 422D, 422E, 424A, 424B, 424C) for impedance matching.

The dielectric support 430 is generally in the shape of an “H”, with slender elongated sides 432A, 432B connected by a cross bar 434 with a thicker cross-section. The center conductor 320 extends through a cavity 436 in the cross bar 434 and may be retained, for example, by a screw 438. Each side 432A, 432B may include two or more tapped holes (e.g. tapped holes 440A, 440B). The polarization converter 400 may be retained within a circular wave guide by screws (not shown) passing through the wall of the circular waveguide and engaging with the tapped holes 440A, 440B.

A polarization converter for use in a feed network, such as the polarization converters 220 and 400, may be designed using a commercial software package such as CST Microwave Studio. An initial model of the polarization converter, including a center conductor and dielectric support, may be generated with estimated dimensions for the length, width, height, and cross-section shape. The structure may then be analyzed, and the reflection coefficients, throughput, and cross coupling may be determined for two orthogonal linearly polarized modes. The dimensions of the model may then be iterated manually or automatically to achieve the desired phase shift and minimize the reflection coefficients across an operating frequency band.

### Closing Comments

Throughout this description, the embodiments and examples shown should be considered as exemplars, rather than limitations on the apparatus and procedures disclosed or claimed. Although many of the examples presented herein involve specific combinations of apparatus elements, it should be understood that those acts and those elements may be combined in other ways to accomplish the same objectives. Elements and features discussed only in connection with one embodiment are not intended to be excluded from a similar role in other embodiments.

For means-plus-function limitations recited in the claims, the means are not intended to be limited to the means disclosed herein for performing the recited function, but are intended to cover in scope any means, known now or later developed, for performing the recited function.

As used herein, “plurality” means two or more.

As used herein, a “set” of items may include one or more of such items.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

As used herein, “and/or” means that the listed items are alternatives, but the alternatives also include any combination of the listed items.

It is claimed:

1. An antenna feed network, comprising:
an asymmetric annular waveguide coupled between first and second cylindrical waveguides,
wherein the asymmetric annular waveguide is configured to transform a linearly polarized signal propagating in the first cylindrical waveguide into a circularly polarized signal propagating in the second cylindrical waveguide.

2. The antenna feed network of claim 1, the annular waveguide comprising a center conductor with a non-circular cross-sectional shape.

3. The antenna feed network of claim 2, wherein the center conductor has a generally rectangular cross-sectional shape.

4. The antenna feed network of claim 2, wherein
the center conductor is symmetric about orthogonal first and second planes, the first and second planes intersecting at an axis of the first and second cylindrical waveguides.

5. The antenna feed network of claim 2, further comprising a dielectric support to hold the center conductor within the asymmetric annular waveguide.

6. The antenna feed network of claim 5, wherein the center conductor and the dielectric support are configured to cause a phase shift of approximately 90 degree between orthogon ally polarized signal propagating in the cylindrical waveguide.

7. The antenna feed network of claim 5, the dielectric support including parallel elongate sides joined by a cross bar, wherein
the center conductor passes through a cavity in the cross bar.

8. The antenna feed network of claim 1, further comprising:
a secondary reflector disposed to receive the circularly polarized signal from the second circular waveguide; and
a primary reflector disposed to receive the circularly polarized signal reflected from the secondary reflector.

9. An antenna feed network, comprising:
a cylindrical waveguide having circular cross-section and a length having a first portion, a central portion and a second end portion; and
a center conductor within the central portion of the cylindrical waveguide,
wherein the center conductor is configured to transform a linearly polarized signal propagating in the first end portion of the cylindrical waveguide into a circularly polarized signal propagating in the second end portion of the cylindrical waveguide.

10. The antenna feed network of claim 9, wherein the center conductor has a non-circular cross-sectional shape.

11. The antenna feed network of claim 10, wherein the center conductor has a generally rectangular cross-sectional shape.

12. The antenna feed network of claim 10, wherein
the center conductor is symmetric about orthogonal first and second planes, the first and second planes intersecting at an axis of the cylindrical waveguide.

13. The antenna feed network of claim 9, further comprising a dielectric support to hold the center conductor within the cylindrical waveguide.

14. The antenna feed network of claim 13, wherein the center conductor and the dielectric support are configured to cause a phase shift of approximately 90 degree between orthogon ally polarized signal propagating in the cylindrical waveguide.

15. The antenna feed network of claim 13, the dielectric support including parallel elongate sides joined by a cross bar, wherein
the center conductor passes through a cavity in the cross bar.

16. The antenna feed network of claim 9, further comprising:
a secondary reflector disposed to receive the circularly polarized signal from the second end of the cylindrical waveguide; and
a primary reflector disposed to receive the circularly polarized signal reflected from the secondary reflector.
